(19) United States
(12) Patent Application Publication
(10) Pub. No.: US 2006/0048967 A1
(43) Pub. Date: Mar. 9, 2006

(54) Sound signal wire

(75) Inventor: Rosa Chang, Taipei (TW)

Correspondence Address: SHOEMAKER AND MATTARE, LTD, 10 POST OFFICE ROAD - SUITE 110, SILVER SPRING, MD, 20910, US

(73) Assignee: Taiwan Maeden Co., Ltd., Taipei (TW)

(21) Appl. No.: 10/995,546

(22) Filed: Nov. 24, 2004

(30) Foreign Application Priority Data
Sep. 6, 2004 (TW) 093126833

(51) Int. Cl. H01B 7/18

(52) U.S. Cl. 174/109

(57) ABSTRACT

A sound signal wire is composed of a first set of weaving wires and a second set of weaving wires wound around periphery the first set of weaving wires. The first and second set of weaving wires respectively include at least a first weaving wire composed of a core and at least two conductive layers wound layer-by-layer to cross over with each other around periphery the core and a second weaving wire. The two adjacent conductive layers of the first weaving wire are wound to cross over with each other, and the two adjacent conductive layers of the second weaving wire are wound in the same direction such that a weaving structure is formed to enhance the structural rigidity and damping constant of the sound signal wire, so as to prevent roping effect occurred as a result of high frequency vibration.

### FIELD OF THE INVENTION

The present invention relates to sound signal wires, and more particularly, to a sound signal wire for transmitting sound signals in a speaker.

### BACKGROUND OF THE INVENTION

Typically, a speaker 1 is assembled with a speaker frame 10, a diaphragm 15, a damper 20, sound signal wires 30, a magnetic circuit, a voice coil bobbin and a voice coil 35 surrounding the voice coil bobbin as illustrated in FIG. 1. A sound signal is transmitted in a form of electric current from a signal input end outside the speaker frame 10 to the voice coil 35 via the sound signal wires 30, so as to generate a magnetic field which is used in association with attraction and repulsion of the magnetic circuit to vibrate the diaphragm 15, resulting a sound production.

In addition, the speaker 1 is generally provided with two sound signal wires 30, each of the sound signal wires 30 is made by weaving and winding a plurality of weaving wires. As shown in FIGS. 2A through to 2C, each of the weaving wires is composed of a core 301 and two conductive layers 303, 305 wound layer-by-layer in a candy-cane fashion around the periphery of the core, and the two adjacent conductive layers are wound in a same direction. The sound signal wire 30 has one end attached to the speaker frame 10 and penetrated the diaphragm 15 to connect to voice coil 35; and the other end of the sound signal wire is connected to the signal input end outside the speaker frame 10, to thereby transmit sound signals and activate the functions of speaker 1.

However, the largest drawback for the sound signal wires 30 lies in its vertical vibration induced along with vibration of the diaphragm 15 as the sound is produced, since the sound is produced by the speaker 1 via the vibration of the diaphragm 15. As the sound signal exceeds a certain frequency, a horizontal or rippled vibration is also generated besides the vertical vibration for the sound signal wires 30, causing a roping effect R, as shown in FIG. 3. As the roping effect of the sound signal wires 30 in the speaker 1 occurs, the wires 30 may hit not only on the diaphragm 15 or the damper 20 to produce noise, but also cause the sound signal wires to collide with each other for short-circuiting the sound signals. Moreover, if tensile strength of the sound signal wire 30 is not strong enough, the wire 30 may easily crack as a result of the vibration.

Meanwhile, the core 301 of each of the weaving wires in the sound signal wire is surrounded by the conductive layers 303, 305, and after the above-mentioned weaving wires are woven or wound into the sound signal wires 30, the sound signal wires formed as such would not have enough structural rigidity, thereby easily causing a roping effect to collide the diaphragm and damper during the vibration.

Alternatively, it is acceptable for a weaving wire (not shown) to be composed of a core 301 and two conductive layers 303, 305 wound layer by layer in opposite directions around the periphery of the core, so as to form the sound signal wires with stronger structural rigidity. However, the weaving wire still suffered from poor flexibility, which still subject the sound signal wires formed therefrom to the roping effect during a high frequency vibration.

Conventionally, an improved speaker damper configuration has been disclosed in U.S. Pat. No. 5,125,473, by which, a sound signal member for transmitting sound signals is fixed on the damper, thereby preventing cracks of the sound signal member having insufficient tensile strength. Moreover, the Taiwan Patent Publication No. 408897 has disclosed a metal conductive layer which is coated over an upper surface or a lower surface of the damper by adopting a vacuum plating method, while formation of the sound signal wires is directly omitted. The metal conductive layer is connected to the voice coil to substitute with a conventional sound signal wire, so as to prevent an occurrence of roping effect and noise production.

Regardless of whether coating a metal conductive layer on a damper or fixing a sound signal member on a damper, it would require many complicated fabrication steps in the above methods. And an imprecise control for the fabrication steps may even result degradation in transmission effect of sound signals, further increasing fabrication difficulty. Meanwhile, it is very costly and unpractical for the industrial manufacturer to apply these methods. Therefore, the industrial requirements are satisfied only when the improvement is directed to the structure of the sound signal wire.

Accordingly, it has become an important issue endeavored by the industrial manufacturer to provide a sound signal wire, which is capable of enhancing the structural rigidity or increasing damping constant of the sound signal wire effectively without occurrence of the roping effect, so as to improve quality of the speaker.

### SUMMARY OF THE INVENTION

In light of the above and other drawbacks, an objective of the present invention is to provide a sound signal wire, which eliminates the roping effect during a high frequency vibration.

Another objective of the present invention is to provide a sound signal wire having stronger structural rigidity.

Still another objective of the present invention is to provide a sound signal wire having higher damping constant.

A further objective of the present invention is to provide a sound signal wire that is easily fabricated.

In order to achieve the aforementioned and other objectives, the present invention proposes a sound signal wire, comprising a first set of weaving wires and a second set of weaving wires wound around the periphery of the first set of weaving wires. The first set of weaving wires having at least a first weaving wire is composed of a core and at least two conductive layers wound layer by layer around the periphery of the core, wherein two adjacent conductive layers are wound to cross with each other. The second set of weaving wires having at least a second weaving wire are wound around the periphery of the first set of weaving wires.

In the above weaving structure, a conductive layer of the first weaving wire is wound layer-by-layer in a candy-cane fashion and the two adjacent conductive layers are wound in opposite directions with a fix angle to the core, preferably as 45 degrees. In a preferred embodiment, the conductive layers completely cover the periphery of the core, and simultaneously, each centimeter of the core is wound with 20 rounds of conductive layer for achieving the desired structural density.

Furthermore, in a preferred embodiment, the core can be made of a fiber, and the textile of the fiber is selected from a group consisting of cotton fiber, rayon fiber, polyester fiber and aromatic polyamide fiber. The conductive layers can be made of a metal is selected from a group consisting of copper, cadmium, tin, sliver and alloys thereof.

In a preferred embodiment, at least one of the second weaving wires is structurally different from the first weaving wire. The second weaving wires can be composed of a core and at least two conductive layers wound layer-by-layer in a candy-cane fashion around the periphery of the core. As a sound signal wire serves for a speaker in accordance with the present invention, such wire is able to solve the problems simultaneously by providing the first set of weaving wires having stronger structural rigidity and the second set of weaving wires having greater flexibility, so as to resolve problems such as complicated fabrication steps, low quality of transmission, increased fabrication difficulty and high fabrication costs associated with the conventional technique.

Therefore, the present invention has satisfied the requirements of rigidity and flexibility for a sound signal wire having greater tensile strength, stronger structural rigidity and higher damping constant, as to prevent the roping effect during a high frequency vibration. Meanwhile, such sound signal wire is also easy to fabricate to sufficiently solve the problems associated with the conventional sound signal wire.

### BRIEF DESCRIPTION OF THE DRAWINGS

FIG. 1 is a schematic diagram of a conventional speaker;

FIGS. 2A through to 2C are weaving schematic diagrams of a conventional sound signal wires, wherein FIG. 2A shows an action of a conductive layer wound around a core, FIG. 2B shows the core wound with the conductive layer, and FIG. 2C shows another conductive layer wound around the core;

FIG. 3 is a schematic diagram of a roping effect for a conventional sound signal wires;

FIG. 4 is a schematic diagram of structure for sound signal wires in accordance with the present invention;

FIG. 5 is a schematic diagram of structure for a first set of weaving wires of sound signal wires as shown in FIG. 4;

FIG. 6 is a schematic diagram of a roping test machine;

FIG. 7A is a schematic diagram showing layouts for the sound signal wires of the present invention and the conventional sound signal wires prior to the roping test; and

FIG. 7B is a schematic diagram comparing the sound signal wire of the present invention and the conventional sound signal wires during roping test.

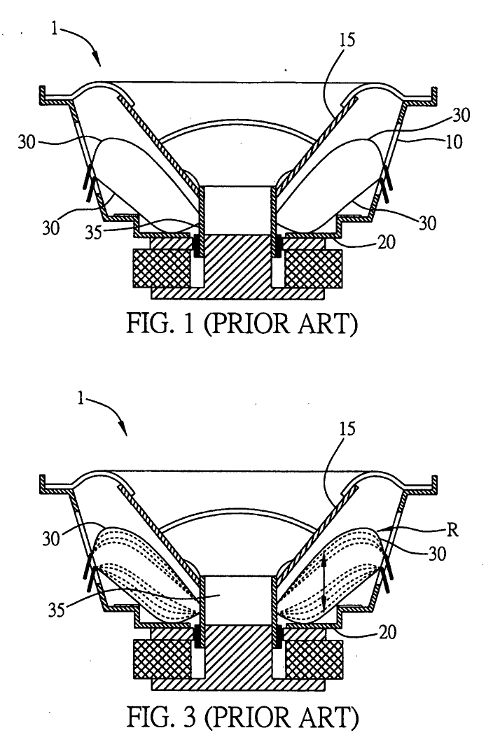

### DETAILED DESCRIPTION OF THE PREFERRED EMBODIMENTS

The present invention is described in the following with specific embodiments, so that one skilled in the pertinent art can easily understand other advantages and effects of the present invention from the disclosure of the invention. The present invention is also implemented and applied according to other embodiments, and details are modified based on different views and applications without departing from the spirit of the invention.

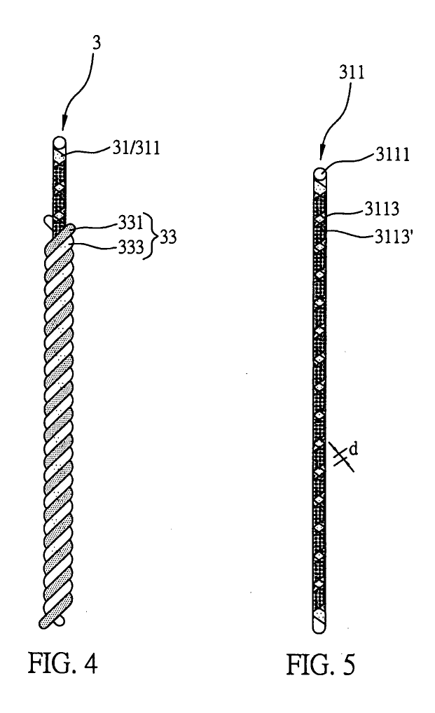

FIGS. 4 through to 7B are illustrative diagrams in accordance with the preferred embodiments of the present invention. Referring to FIG. 4, a sound signal wire 3 used in a speaker is provided, the sound signal wire comprising a first set of weaving wires 31 and a second set of weaving wires 33 wound around the periphery of the first set of weaving wires 31. In the embodiment of exemplary illustration herein, the first set of weaving wires 31 includes at least one first weaving wire 311 arranged in a straight line, but the first set of weaving wires 31 should not be limited as such. The speaker itself is conventional without any further structural change, and it is not the feature of the invention. Thus, the related descriptions and drawings thereof are omitted herein.

As shown in FIG. 5, the first weaving wire 311 is composed of a core 3111 and two conductive layers 3113, 3113′ wound layer-by-layer to cross over with each other around the periphery of the core 3111, wherein the two adjacent conductive layers 3113, 3113′ are wound in opposite directions and wound at a fix angle to the core 3111. It should be noted that a first weaving wire 311 can be made of two or more conductive layers, even though the exemplary embodiment herein is described using two conductive layers 3113, 3113′, as long as the two adjacent conductive layers 3113, 3113′ are wound in opposite directions to cross over with each other and each at a fix angle to the core 3111, preferably at 45 degrees.

More specifically, the conductive layer 3113 is wound in a manner where the conductive layer 3113 is wound in an unidirectional fashion to completely cover the periphery of the core 3111. However, the angle at which the core 3111 is wound with conductive layer is not limited to 45 degrees as previously mentioned and the number of conductive layers 3113 is not only limited to two. A design with winding of multiple layers may also be adopted so as to enhance the structural rigidity of the sound signal wire 3 as long as two adjacent conductive layers wound in opposite directions to cross over with each other.

Moreover, the preferable winding density for each of the conductive layers 3113 is: 20 rounds of the conductive layer wound on each centimeter of the core 3111 for enhancing the effects of the present invention. That is, each centimeter of the core 3111 has 20 layers of the conductive layer 3113 with a winding gap of d as shown in FIG. 5. Thus, the sound signal wire 3 can now achieve higher structural density and stronger structural rigidity.

The aforementioned core 3111 can be formed by fiber and each conductive layer 3113 can be made of a metal, wherein the textile of fiber is selected from a group consisting of cotton fiber, rayon fiber, polyester fiber and aromatic polyamide fiber; the metal is selected from a group consisting of copper, cadmium, tin, silver and alloys thereof, but preferably a copper foil is used in this case.

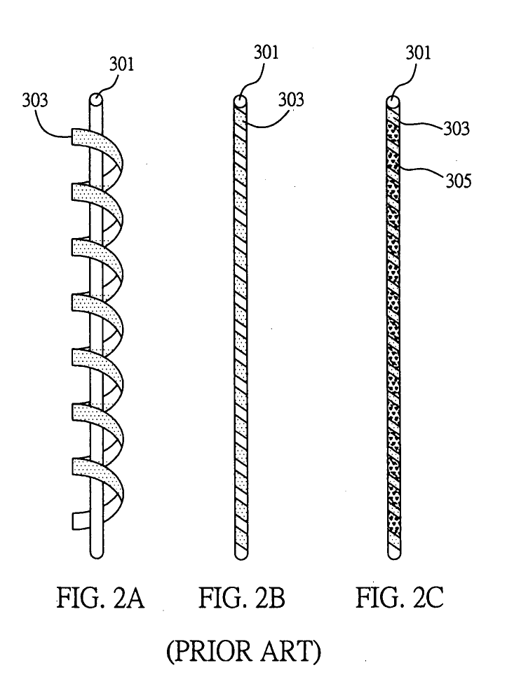

The second set of weaving wires 33 comprise at least a second weaving wire, in the embodiment herein is using two second weaving wires 331, 333 for an exemplary as shown in FIG. 4. Each second weaving wire 331, 333 is composed of a core and at least two conductive layers wound layer-by-layer in candy-cane fashion around the periphery of the core, that is, at least one second weaving wire 331, 333 is identical with a conventional sound signal wire 30 showing in FIG. 2C. The methods of conventional sound signal wire 30 would not further explain herein.

The winding structure of second weaving wires 331, 333 in the second set of weaving wires is wound layer-by-layer in a same direction, as to have better flexibility and higher damping constant. That is, a sound signal wire 3 having stronger structural rigidity and higher damping constant is formed by the first set of weaving wires 31 and the second set of weaving wires 33 to satisfy the needs for rigidity and flexibility of sound signal wires, and to thereby prevent roping effect occurred as a result of high frequency vibration.

Meanwhile, the sound signal wire 3 of the present invention is easily fabricated to resolve drawbacks such as complicated fabrication steps, low quality of transmission, increased fabrication difficulty and high fabrication costs associated with the conventional technique.

The first set of weaving wires 31 and the second set of weaving wires 33 may contain 8, 12, 16, 20 and 24 strands of weaving wires depending on a model of a weaving machine. That is, the first set of weaving wires 31 are selected from a group consisting of 8, 12, 16, 20 and 24 strands of first weaving wires, and the second set of weaving wires 33 are also selected from a group consisting of 8, 12, 16, 20 and 24 strands of second weaving wires, but not limited to the number of strands as described herein. For example, a 8-strand sound signal wire is fabricated by a rotationally weaving process through the use of a weaving machine with 8 rollers, wherein the rollers are arranged in a circle, and each roller is wound with a strand of wire in a circular track to perform the rotationally weaving process, so as to form the sound signal wire having 8 strands of the weaving wires. Similarly, a sound signal wire with 12, 16, 20 or 24 strands of weaving wires is fabricated by a weaving machine with 12, 16, 20 or 24 rollers, respectively. As the weaving method is a conventional art, further explanation on the different number of strands are omitted herein.

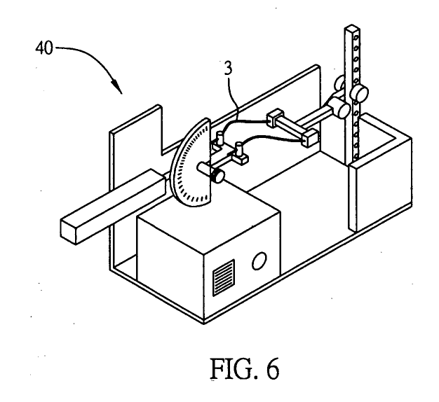

Accordingly, the weaving structure of sound signal wire 3 showing in FIG. 4 can enhance the structural rigidity and damping constant of the sound signal wire 3, to thereby prevent roping effect during a high frequency vibration. Referring to FIG. 6, the effect of sound signal wire 3 is illustrated using a roping tester 40 according to the present invention, wherein two ends of the sound signal wire 3 are fixed by the roping tester 40. The roping tester 40 is initiated to vibrate the wire 3, so as to simulate waveform and amplitude of a high frequency vibration effect to the sound signal wire 3 in the speaker.

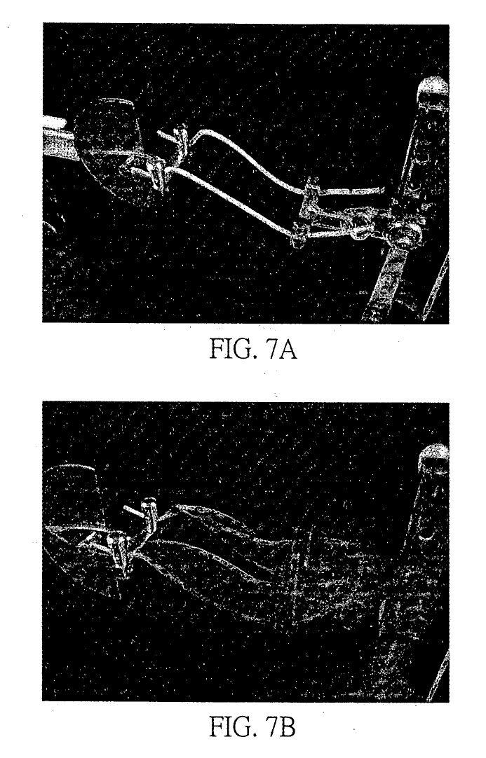

FIGS. 7A and 7B are photographs illustrating results in roping test. Firstly, a conventional sound signal wire and a sound signal wire of the present invention are individually fixed to the roping tester 40, as shown in FIG. 7A, wherein the conventional sound signal wire is illustrated at upper portion of FIG. 7A and the sound signal wire of present invention is illustrated at lower portion of FIG. 7A, so that a high frequency vibration of the sound signal wires is simulated via the tester 40 in the speaker.

FIG. 7B shows the simulation result of roping effect initiated by the roping tester 40. The sound signal wires vibrate in high frequency during the testing, where the conventional sound signal wire having weak structural rigidity and low damping constant induces a large amplitude of circling vibration than the sound signal wire of present invention, resulting a roping effect. This roping effect may distort the sound due to sound signal wire collided with diaphragm and damper at inner of speaker. On contrary, the design of sound signal wire according to the present invention is significantly enhanced in structural rigidity and damping constant, so that the vibration and amplitude thereof become stable, eliminating roping effect. Also, quality of sound signal transmission is enhanced.

Furthermore, the design of present invention is to alter the structure of sound signal wire without implementing complicated fabrication steps and altering the material of sound signal wire and further without changing the principle design of speaker, thereby achieving benefits of easy fabrication and low fabrication cost.

It should be understood from above descriptions, as compared with the prior art, the present invention proposes a sound signal wire having greater tensile strength, stronger structural rigidity and higher damping constant, so as to prevent roping effect during a high frequency vibration. Simultaneously, it is easily fabricated to significantly solve the problems associated with the prior art.

The present invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A sound signal wire, at least comprising:
a first set of weaving wires having at least a first weaving wire, the first set of weaving wire being composed of a core and at least two conductive layers wound layer-by-layer around a periphery of the core, wherein the two adjacent conductive layers are wound to cross over with each other; and
a second set of weaving wires wound around a periphery of the first set of weaving wires, wherein the second set of weaving wires having at least a second weaving wire.

2. The sound signal wire of claim 1, wherein the core is fiber.

3. The sound signal wire of claim 2, wherein a textile of the fiber is selected from a group consisting of cotton fiber, rayon fiber, polyester fiber and aromatic polyamide fiber.

4. The sound signal wire of claim 1, wherein the conductive layers are metals.

5. The sound signal wire of claim 4, wherein the metals are selected from a group consisting of copper, cadmium, tin, sliver and alloy thereof.

6. The sound signal wire of claim 1, wherein each of the conductive layers is wound in a unidirectional manner.

7. The sound signal wire of claim 1, wherein the two adjacent conductive layers are wound in opposite directions to cross over with each other, and the two adjacent conductive layers are wound at a fixed angle to the core.

8. The sound signal wire of claim 7, wherein the angle is 45 degrees.

9. The sound signal wire of claim 1, wherein the conductive layers completely cover the periphery of the core.

10. The sound signal wire of claim 1, wherein each centimeter of the core is wound with 20 rounds of the conductive layers.

11. The sound signal wire of claim 1, wherein the first set of weaving wires is selected from a group consisting of 8, 12, 16, 20 and 24 strands of first weaving wire.

12. The sound signal wire of claim 1, wherein the second set of weaving wires is selected from a group consisting of 8, 12, 16, 20 and 24 strands of second weaving wire.

13. The sound signal wire of claim 1, wherein at least one of the second weaving wires is structurally different from the first weaving wires.

14. The sound signal wire of claim 13, wherein the second set of weaving wire is composed of a core and at least two conductive layers wound side-by-side around a periphery of the core, and the two adjacent conductive layers are wound in the same direction.

15. The sound signal wire of claim 14, wherein the core is fiber.

16. The sound signal wire of claim 15, wherein a textile of the fiber is selected from a group consisting of cotton fiber, rayon fiber, polyester fiber and aromatic polyamide fiber.

17. The sound signal wire of claim 14, wherein the conductive layers are metals.

18. The sound signal wire of claim 17, wherein the metals are selected from a group consisting of copper, cadmium, tin, silver and alloy thereof.

19. The sound signal wire of claim 14, wherein the conductive layers completely cover the periphery of the core.
